(19) United States
(12) Patent Application Publication
(10) Pub. No.: US 2010/0062122 A1
(43) Pub. Date: Mar. 11, 2010

(54) Batter product baking technology

(75) Inventors: Jeffrey L. Casper, Minneapolis, MN (US); William Alan Atwell, Champlin, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/283,116

(22) Filed: Sep. 9, 2008

(51) Int. Cl. A21D 13/00; A21D 15/06

(52) U.S. Cl. 426/243; 426/497; 426/549

(57) ABSTRACT

The present invention provides methods and compositions for preparing fully-sponge-state batter products.

### BACKGROUND

Consumers' desire for high quality freshly prepared baked goods is often in conflict with the need for restaurants and in-store bakeries to reduce cost, reduce the need for highly skilled labor, and reduce the time needed to prepare products. Additionally, the equipment required to produce products from scratch require valuable space in many operations.

Many time- and labor-saving batter products have been produced to address these problems, including complete dry mixes, refrigerated batter products, and frozen batter products in bulk and pre-portioned forms. While these products increase the simplicity of use, they either create, or do not address, some significant issues. Frozen and refrigerated batter products can lose leavening power over time, resulting in inconsistent and/or poor baked volumes. Polyphenol oxidase enzyme activity in refrigerated and frozen batters can render those products gray in color. Thawed frozen batters must be used within a short period of time due to loss of leavening or risk of microbial growth and spoilage. The convenience of handling these products varies. Further, the bake times for all of these products are similar to that of a freshly prepared batter.

### SUMMARY OF CERTAIN EMBODIMENTS OF THE INVENTION

Certain embodiments of the present invention provide methods of producing a frozen fully-sponge-state batter product that can be further baked from a frozen state in a rapid bake oven to provide a finished baked product with a color, aroma, texture, and flavor of a freshly baked batter product, where the method involves the steps of depositing a batter composition into a desired form, applying heat to the batter until the batter has completed the foam to sponge transition throughout the batter composition, and/or has developed a crust thickness of less than 400 micrometers, and freezing the fully-sponge-state batter product. As used herein, the terms “fully-sponge-state” or “fully baked” mean that the batter composition has completed the foam to sponge transition throughout the batter composition. In other words, none of the remaining batter is raw. In a “fully-sponge-state” batter product, the starch has been completely gelatinized, and the structure has completed the transition from an air discontinuous foam to an air continuous sponge structure. Also, in a “fully-sponge-state” batter product, the leavening activity of the leavening system is complete. Methods of determining the degree of foam or sponge state of a batter composition are generally known in the art, which include simple visual assessments of a cross section, or more complex microscopic, x-ray tomographic, and image analysis measurements of the product structure. The use of these terms “fully-sponge-state” and “fully-baked” is consistent with the conventional use of these terms by those of skill in the art. In certain embodiments, a fully-sponge-state batter product may not have a fully-formed crust, or may have formed only a minimal crust. In certain embodiments, a fully-sponge-state batter product may not have achieved its final coloration.

In certain embodiments, the fully-sponge-state batter product is a white flour fully-sponge-state batter product and wherein the crust has a calorimeter L*-value of greater than about 65. In certain embodiments, the fully-sponge-state batter product is a white flour fully-sponge-state batter product and wherein the crust has a colorimeter L*-value of between 70 and 80. In certain embodiments, the fully-sponge-state batter product is a white flour fully-sponge-state batter product and wherein the crust has a calorimeter a*-value of less than about 5.0. In certain embodiments, the fully-sponge-state batter product is a white flour fully-sponge-state batter product and wherein the crust has a colorimeter a*-value of between 3.5 and 1.5. In certain embodiments, the fully-sponge-state batter product has a crust thickness between 200 and 100 micrometers. In certain embodiments, the freezing is by blast freezing to an internal temperature of −10° F. to −40° F. In certain embodiments, the fully-sponge-state batter product has a moisture content of 15-40% after the initial-bake process is completed. As used herein, the term “initial-bake” means that the batter composition has reached the fully-sponge-state, but has not formed a significant crust, has not achieved its final coloration, and has about 105-110% moisture content as compared to a comparable finish-baked batter product. As used herein, the term “finish-baked” means a batter product that is fully-sponge-state and has developed a crust and coloration that are customarily accepted by consumers for the particular batter product. In certain embodiments, the fully-sponge-state batter composition is tempered to an internal temperature of about 55° F. to 120° F. prior to initial baking. In certain embodiments, the fully-sponge-state batter product is exposed to steam during initial baking. In certain embodiments, the fully-sponge-state batter product is cooled to an internal temperature of less than about 140° F. prior to freezing. In certain embodiments, the fully-sponge-state batter product is cooled by vacuum cooling. In certain embodiments, the batter composition includes a leavening system comprising a heat activated acidulant. Examples of heat activated acidulants include dicalcium phosphate dehydrate, sodium aluminum phosphate, and/or dimagnesium phosphate. In certain embodiments, the leavening system further includes a second leavening agent. In certain embodiments, the second leavening agent is sodium acid pyrophosphate, calcium acid pyrophosphate, anhydrous monocalcium phosphate, monocalcium phosphate, or sodium aluminum phosphate. In certain embodiments, the initial baking is performed by an electrical resistance oven. In certain embodiments, the rapid bake oven is a combination air impingement/microwave oven or a radiant heat oven.

Certain embodiments of the present invention provide methods of producing a frozen fully-sponge-state batter product that can be further baked from the frozen state in a rapid cook oven to provide a finished baked product with the color, aroma, texture, and flavor of a freshly baked batter product, where the methods involve depositing a batter composition into a desired form, and applying heat to the batter until the batter has 100% sponge structure and has a crust with an L*-value of greater than about 65 (L values that are higher are closer to pure white). In certain embodiments, the fully-sponge-state batter product is a white flour batter product and wherein the crust has a colorimeter L*-value of between 75 and 85. In certain embodiments, the fully-sponge-state batter product is a white flour batter product and wherein the crust has a colorimeter a*-value of less than about 5.0. In certain embodiments, the fully-sponge-state batter product is a white flour batter product and wherein the crust has a calorimeter a*-value of between 3.5 and 1.5. Certain embodiments of the present invention provide methods of producing a frozen fully-sponge-state batter product that can be further baked from the frozen state in a rapid cook oven to provide a finished baked product with the color, aroma, texture, and flavor of a freshly baked batter product, where the method involves depositing a batter composition into a desired form, and applying heat to the batter until the batter has 100% sponge structure and a moisture content of between 105% and 110% of the finished baked product. Certain embodiments of the present invention provide methods of finish baking a frozen fully-sponge-state batter product, where the method involves placing the frozen fully-sponge-state batter product into a combination air impingement/microwave oven or a radiant heat oven, and finish baking the batter product for less than five minutes. As used here in the term “finish baking” is defined as a baking process that generates rapid color development of the exterior to an L* and a* value typical of a fully baked reference batter product, and wherein the interior temperature of the batter product is greater than 70° F. In certain embodiments, the finish baking step is for less than two minutes.

Certain embodiments of the present invention provide fully-sponge-state batter products having 100% sponge structure, a moisture content of between 105% and 110% of a corresponding finished baked product, and a crust thickness of less than 400 micrometers. In certain embodiments, the fully-sponge-state batter product has a crust thickness between 200 and 100 micrometers. In certain embodiments, the batter product is a white flour batter product and wherein the crust has a calorimeter L*-value of greater than about 65. In certain embodiments, the fully-sponge-state batter product is a white flour batter product and wherein the crust has a colorimeter L*-value of between 75 and 85. In certain embodiments, the fully-sponge-state batter product is a white flour batter product and wherein the crust has a calorimeter a*-value of less than about 5.0. In certain embodiments, the fully-sponge-state batter product is a white flour batter product and wherein the crust has a calorimeter a*-value of between 3.5 and 1.5.

Certain embodiments of the present invention provide a dry premix composition for preparing a batter product that includes a heat activated leavening system, such as a heat activated acidulant. In certain embodiments, the heat activated acidulant is dicalcium phosphate dehydrate, sodium aluminum phosphate, and/or dimagnesium phosphate. In certain embodiments, the leavening system further comprises a second leavening agent. In certain embodiments, the second leavening agent is sodium acid pyrophosphate, calcium acid pyrophosphate, anhydrous monocalcium phosphate, monocalcium phosphate, or sodium aluminum phosphate.

### BRIEF DESCRIPTION OF THE FIGURES

The patent or application file contains at least one drawings executed in color. Copies of this patent or parent application publication with color drawing(s) will be provided to the Office upon request and payment of the necessary fee.

FIGS. 1A-1G. FIG. 1A shows a cross section of a muffin that was baked for 7 minutes and then frozen. FIG. 1B shows a cross section of a muffin that was baked for 14 minutes and then frozen. FIG. 1C shows a cross section of a muffin that was baked for 21 minutes and then frozen. FIG. 1D shows a cross section of a muffin baked for 28 minutes (i.e., a fully-baked control muffin) and then frozen. FIG. 1E shows cross sections of the control muffin; a muffin that was baked for 7 minutes, frozen, and then finish baked for 21 minutes; and the muffin from FIG. 1A. FIG. 1F shows cross sections of the control muffin; a muffin that was baked for 14 minutes, frozen, and then finish baked for 18 minutes; and the muffin from FIG. 1B. FIG. 1G shows cross sections of the control muffin; a muffin that was baked for 21 minutes, frozen, and then finish baked for 11 minutes; and the muffin from FIG. 1C.

FIG. 2 shows a commercial mix baked at 400° F. The numbers above each muffin indicates the length of baking time, i.e., 5, 10, 15, 20, or 25 minutes of baking.

FIG. 3 shows a test mix with heat activated leavening baked at 400° F. The numbers above each muffin indicates the length of baking time, i.e., 5, 10, 15, 20, or 25 minutes of baking.

FIG. 4 shows a commercial mix baked at 300° F. The numbers above each muffin indicates the length of baking time, i.e., 5, 10, 15, 20, 25, or 30 minutes of baking.

FIG. 5 shows a test mix with heat activated leavening baked at 300° F. The numbers above each muffin indicates the length of baking time, i.e., 5, 10, 15, 20, 25, or 30 minutes of baking.

FIG. 6 provides colorimeter data for products shown in Example 2. The colorimeter data is presented for commercial (Betty Crocker®) and test samples baked at 300° and 400° F. The 300° temperature treatment represents a low temperature bake process. The 400° F. temperature treatment represents the recommended temperature for the commercial sample. The graphs are set up so one can compare common temperatures between formulas across rows, or compare a common formula between temperatures.

FIG. 7 provides the electrical resistance oven profiles of commercial and test batters. The plot shows the relationship between temperature and batter viscosity, and shows features such as leavening activity over a temperature range.

FIGS. 8A-8F provide comparisons of muffins prepared under various conditions. FIG. 8A shows a muffin where the batter temperature was at 70° F. that was baked at 300° F. for 30 minutes. FIG. 8B shows a muffin where the batter temperature was at 70° F. that was baked at 400° F. for 10 minutes. FIG. 8C shows a muffin where the batter temperature was at 100° F. that was baked at 400° F. for 10 minutes. FIG. 8D shows a muffin where the batter temperature was at 70° F. that was baked at 400° F. for 30 minutes. FIG. 8E shows a muffin where the batter temperature was at 85° F. that was baked at 350° F. for 15 minutes. FIG. 8F shows a muffin where the batter temperature was at 100° F. that was baked at 400° F. for 10 minutes.

FIGS. 9A-9I provides a comparison of fully baked and tempered, par-baked batter products before and after finish baking. FIG. 9A shows a fully baked control muffin; FIG. 9B shows a muffin parbaked at 350° F. for 17 min.; FIG. 9C shows a muffin parbaked at 400° F. for 14 min.; FIG. 9D shows a fully baked control muffin; FIG. 9E shows the parbaked muffin in FIG. 9B finish baked in a rapid cooking combination oven; FIG. 9F shows the parbaked muffin in FIG. 9C finish baked in a rapid cooking combination oven ; FIG. 9G shows a cross section of the fully baked muffin shown in FIG. 9D; FIG. 9H shows a cross section of the muffin shown if FIG. 9E; and FIG. 91 shows a cross section of the muffin shown in FIG. 9F.

### DETAILED DESCRIPTION

Parbake (also called par-baked or partial-baked) products address issues commonly associated with frozen or refrigerated unbaked products. While parbake breads are common, parbake batter products have not been found in the market. A “batter” product is a composition that flows in a reasonable amount of time, such as minutes, from one vessel to another. Traditional “batters” are distinguishable from a traditional “dough” in that a dough is typically lower in free water content, while the free water content of batters is high. This high water content results in a material that rheologically has a low yield stress, while a batter will have a much higher yield stress. In common terms, this means that the amount of force required to deform the batter will be much lower than that of a dough. Additionally, bread type doughs are typically made from a high protein flour where the protein has been developed, or polymerized to a high degree, whereas a traditional muffin, quick-bread, or cake batter is not developed and generally is made from a low protein flour.

Many technical challenges arise when attempting to obtain a fully baked batter product that possesses little to no crust formation and lack of color development. Further, using conventional oven technologies, fully baked batters without crust and color offer no benefit over fully baked or batter products that do possess crust and color development. The time required to reheat or refresh a frozen fully baked batter without crust or color development in a convection type oven can be 25-50% of the time required to take a batter from its initial raw state to a fully crusted and colored product due to the thermal properties of a porous material like muffin crumb. Likewise, cooking a frozen batter product, such as a muffin, in a microwave oven has many disadvantages, including uneven heating, dehydration, microwave induced toughening, and lack of color and flavor development. The recent development of rapid cooking combination oven technologies, such as those from TurboChef™ and Merrychef® offer the ability to rapidly cook and develop a crust with color and flavor. Utilizing these types of ovens offers the ability to create baked goods with the quality of conventionally prepared products in one to five minutes. Challenges still exist, however, to optimize the batter and baking conditions so that a high quality batter product is produced.

The inventors have discovered that it is important during the baking process to fully bake the batter and thus maximize the creation of structure though the complete gelatinization of starch and the denaturation of gluten, while eliminating or minimizing crust formation, and flavor and color development. Several approaches were attempted to achieve these objectives. One way included simply shortening the bake time and maintaining the bake temperature. Another approach was to lower the bake temperature and increase the bake time. In both of these scenarios, the parbake product was frozen and would be distributed to the customer where the remainder of the bake (i.e., “finish baking”) occurs.

During the finish bake, the flavor, color, and crust development occurs. Crust development occurs as the outer surface of the batter as it loses moisture, becomes more viscous, and sets. This material becomes brittle and fractures as the internal pressure of the batter that has not set beneath this material increases. This results in a densification of the porous material. Additionally, starch does not fully gelatinize on the surface of the crust, as the rapid increase of temperature in this portion of the batter does not allow for swelling and the complete loss of crystallinity of the starch.

Color and appearance of a food is the first determinate of product quality by a consumer. Acceptable finished baked good quality can therefore be partially defined as having adequate but not excessive color formation. Because the development of color is directly associated with the high temperatures that concurrently occur after the dehydration of the surface of a batter, color can be used as an indicator of crust development. By minimizing color, one can also conclude that crust development will have been minimized. The CIE (Commission Internationale d'Eclairage, or the International Commission of Illumination) L* a* b* system is a standard reference model for describing color, where L* represents the lightness of a sample, a* represents the position between green and red, and b* represents the position between blue and yellow. These values are unitless.

Additionally, color formation concurrently occurs with the development of flavor compounds. Volatile compounds generated through the maillard reaction are major contributors to the flavor of baked products. These volatiles can be lost over time, even when the product is frozen. Frozen fully-baked products can often have a “flat” or stale flavor that lacks the complexity and fullness of a freshly baked product. When a frozen fully baked product is subjected to microwaving, the generation of steam can also further degrade the flavor quality by volatilizing remaining flavor compounds.

The present invention provides improvements in food service and consumer batter products. In particular, the present invention provides a crustless, colorless, fully sponge-state batter product that can be placed in a rapid cook oven in order to generate crust and color, resulting in the same organoleptic quality as a conventionally baked product, but where the browning and crust development process is only about 10 to 30% of the time that it would take using a conventional method, and there would not be excessive dehydration due to the long period of time required in the conventional oven. Examples of rapid bake ovens include air impingement/microwave combination ovens (e.g., Merrychef™ and Turbochef® ovens) and radiant heat ovens, such as a halogen oven (e.g., GE Advantium® oven). The crust can be developed in the rapid cook oven, and this can be measured by light microscopy or x-ray tomography for all batters, and by colorimeter measurements for white flour based batters. The fully-sponge-state batter products may have a higher moisture content as compared to a traditionally baked product, but after the crust development process in a rapid bake oven, they have a moisture similar to a conventional fully baked product. The present batter products are easier and less messy to use than dry mix, refrigerated, or frozen batter products and do not require added ingredients, utensils, or baking pans. Additionally, the present invention has no active leavening step during the finish bake. Therefore, the finished product will be more consistent than a finished product made from any refrigerated or frozen batter, where leavening power can be lost over time, resulting in decreasing baked volumes and an associated change in texture.

The invention could be improved by utilizing a leavening system where the primary acidulant is a heat activated leavening acid that is activated during the gelatinization of starch. This is advantageous to the product as it was surprisingly found that crust, color, and flavor development could be prevented by tempering the batter to a high temperature prior to baking. Traditional leavening acids begin to react at temperatures found to be advantageous to the production of the present invention. The combination of this formula and process was surprisingly found to give a finished product that had little color, flavor, and crust development and could be baked in a short time at high temperature. One would expect that the effects of tempering a batter would include loss of leavening and a deleterious change in viscosity that results in loss of doming in applications such as muffins. Reducing the temperature differential between the interior of the batter and the temperature of the air in the oven reduced the amount of energy input required to gelatinize the starch and create a sponge structure from the batter foam. This in turn meant less time required in the oven, and the less time the surface had to form a crust structure. The use of heat activated leavening such as DCPD allows for stability during tempering and reacts late enough where the viscosity has increased to a point that doming occurs in applications such as muffins.

Although the invention is specifically described in forms such as muffins, quickbreads, cupcakes, cornbread, layer cakes, and cupcakes, a batter composition can be formulated and baked for use to prepare other product forms, such as pancakes, waffles, crepes, and crumpets.

Fully-sponge-state Batter Products

A “fully-sponge-state” batter product is a product that is baked to a point where the crumb has fully set, but before color has developed. In the present invention, heat is applied to the batter until the batter has fully transitioned from a foam structure (gas discontinuous) to a sponge structure (gas continuous). The completion of the transition of the structure from foam to sponge can be easily identified by one familiar in the art. A simple visual inspection of the cross section will suffice in determining if the transition is complete. In the present invention, while the batter product is baked to 100% foam structure (fully set, continuous), but it has not attained a color or crust thickness typical of a traditionally baked batter product. A fully-sponge-state batter product of the present invention has minimal crust thickness at completion of the bake; the crust formation takes place during the browning process. Crusting takes place as moisture is driven off with heat. The crust thickness is initially much lower than that found in a traditional batter product prior to browning in a rapid combination oven, with values of less than 400 micrometers.

In certain embodiments of the present invention, a fully-sponge-state batter product has a color development of L=75, a=1.5, and/or b=35.

The following examples are intended to further describe, but not limit the present invention.

### EXAMPLE 1

A commercial muffin mix (Betty Crocker® Wild Blueberry Premium Muffin Mix) was prepared to evaluate muffins at varying bake temperatures and times. Batter was prepared according to directions except that the blueberries were not mixed into the batter. Two muffin mixes, 200 g of whole liquid egg, 140 g of soybean oil, and 380 g of water were added to a Hobart™ N-50 mixing bowl. The batter was mixed using a paddle attachment for 60 seconds on low speed. The bowl was then scraped down and mixed on low speed for an additional minute.

Batter was deposited into paper cup lined muffin pans with a target mass of 60 g ±1 g per cup. The product was baked at 425° F. Samples were removed from the oven in 7 minute increments (estimated total bake time divided by 4), allowed to cool, and were blast frozen in a commercial blast freezer to −20° F. Upon freezing, the samples were then placed back in the oven set at 425° F. and baked until complete.

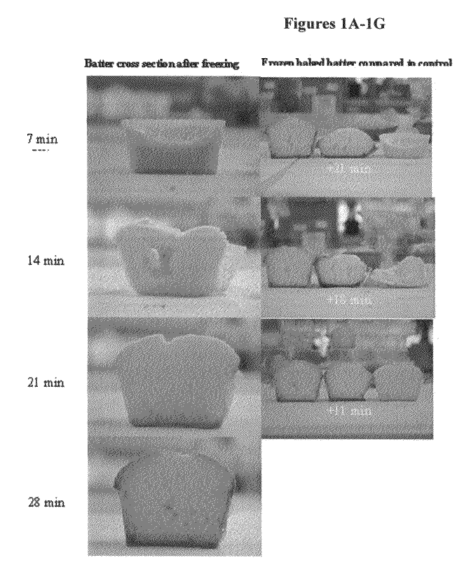

FIGS. 1A-1D show the evolution of the batter as it progresses from a gas discontinuous foam to a gas continuous crumb. After 7 minutes of baking, the batter has not yet begun to form any crumb (FIG. 1A). After 14 minutes, crumb development was evident on the exterior of the cup, and had progressed inwards as (FIG. 1B). Between 14 minutes and 21 minutes, the entire muffin had made the transition from batter to crumb, but had not yet reached what one would describe as being a fully baked color, which would lead one to conclude that at this point the product would be defined as “fully-sponge-state” (FIG. 1C). Ideal full color development was reached at approximately 25 minutes. Between 21 and 28 minutes, a significant thickening of the crust was observed (FIG. 1D).

When placed back in the oven, the frozen samples from each time point took an additional amount of time to reach a baked state where the color matched the 28 minute “fully baked” sample. The additional amount of time required, when added to the previous amount of time in the oven, demonstrated that the use of a conventional oven would require the same total time or up to an additional 4 minutes to reach the same endpoint in terms of color. This example demonstrates the limited utility of using a conventional oven to take a parbake product to the fully-baked endpoint as determined by acceptable color and crust formation. Furthermore, some significant defects were observed in the crumb of the products prior to 21 minutes of bake time. Finished baked product, as shown in FIGS. 1E-1G, does not possess the tunneling and slumping found in the product that was finished baked from the frozen par-bake state.

### EXAMPLE 2

A commercial muffin mix (Betty Crocker® Wild Blueberry Premium Muffin Mix) was prepared to evaluate muffins at varying bake temperatures and times. Batter was prepared according to directions except that the blueberries were not mixed into the batter. Two muffin mixes, 200 g of whole liquid egg, 140 g of soybean oil, and 380 g of water were added to a Hobart™ N-50 mixing bowl. The batter was mixed using a paddle attachment for 60 seconds on low speed. The bowl was then scraped down and mixed on low speed for an additional minute.

A second test muffin batter containing heat-activated leavening was prepared according to the following formula:

TABLE 1
Batter Composition Containing Heat Activated Leavening

| Formula | Ingredient | Formula % |
|---|---|---|
| Dry Premix | Flour | 49.10 |
| | Sugars | 38.95 |
| | Fat source | 3.46 |
| | Dicalcium Phosphate Dihydrate | 2.22 |
| | Modified Corn Starch | 2.04 |
| | Salt | 1.13 |
| | Sodium Bicarbonate | 0.88 |
| | Nonfat milk powder | 1.54 |
| | Emulsifier | 0.63 |
| | Flavoring | 0.22 |
| | Sodium Aluminum Phosphate | 0.15 |
| | Hydrocolloid | 0.13 |
| | Total | 100.00 |
| Batter | Dry Premix (as shown) | 60.10 |
| | Water | 22.50 |
| | Vegetable Oil | 8.40 |
| | Liquid Egg | 9.00 |
| | Total | 100.00 |

The batter formulated according to that shown in Table 1 was mixed using a paddle attachment for 60 seconds on low speed. The bowl was then scraped down and mixed on medium speed for an additional 2 minutes.

Batter was deposited into paper cup lined muffin pans with a target mass of 60 g ±1 g per cup. The product was baked at 400° F. and replicated a second time at 300° F. for comparative purposes. Samples were removed from the oven in 5 minute increments until the degree of color formation was deemed complete for a fully baked muffin, allowed to cool, and were blast frozen in a commercial blast freezer to −20° F. Upon freezing, the samples were measured for maximum height (at the top of the crown), maximum width, and color using a Minolta colorimeter. The L*a*b* color space was used for reporting color, as it is the one that is commonly used in food measurement.

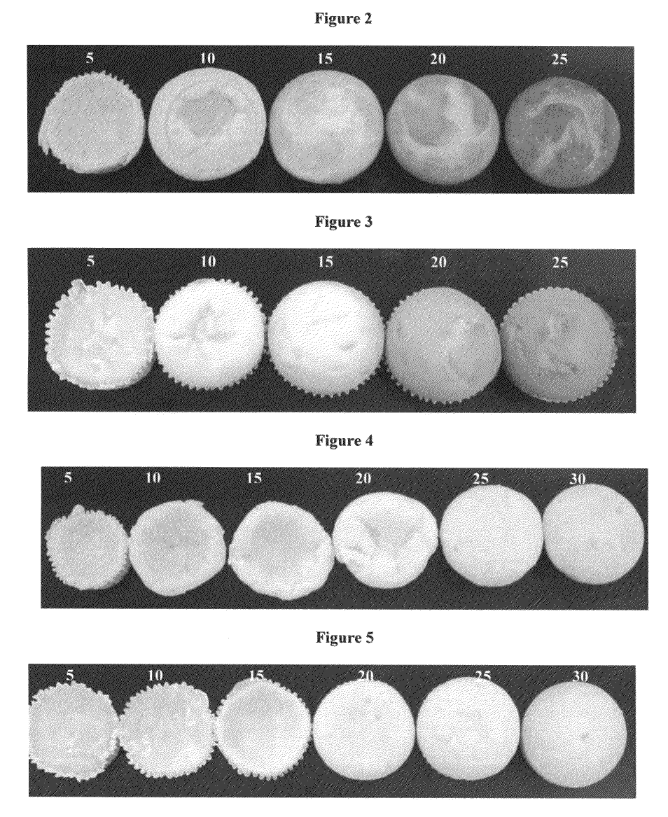

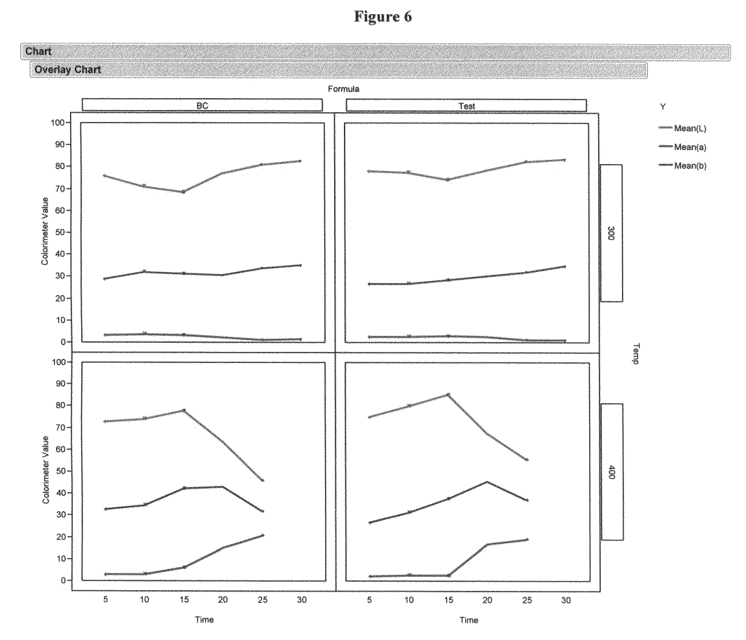

Products and results from Example 2 are shown in FIGS. 2, 3, 4, 5 and 6. Products baked under a typical muffin bake temperature of 400° F. show a rapid drop in L* values after 15 minutes, which is a measure of the lightness or darkness of the sample. Likewise, the a* values begin to climb rapidly after 15 minutes of baking at 400° F. Finished color appears to be acceptable after 20 minutes, which corresponds with these changes in a* and L* values. From this example we can see that browning resulting in an L* value below 65 indicates a baked crust or surface. Additionally, an a* value above 5 indicates malliard browning products increasing to a level where one trained in the art would assume the product is fully baked. At 300° F., both the commercial mix and the test mix showed no to little browning, even after 30 minutes. Colorimeter data supports this finding, as shown in FIG. 4. Little net change was recorded in L* values, a* values, or b* values when baked under these conditions.

Moisture data was collected on the samples. As expected, moisture loss was more rapid at 400° F. than at 300° F.

TABLE 2
Moisture of commercial and test batters baked at two
temperatures over the bake period.

| Variable | 5 min. | 10 min. | 15 min. | 20 min. | 25 min. | 30 min. |
|---|---|---|---|---|---|---|
| Commercial; | 36.1 | 36.4 | 35.0 | 34.1 | 31.8 | 31.8 |
| 300° F. | | | | | | |
| Test; 300° F. | 32.7 | 32.4 | 32.3 | 30.6 | 29.2 | 28.4 |
| Commercial; | 33.1 | 31.8 | 29.4 | 25.5 | 24.1 | — |
| 400° F. | | | | | | |
| Test; 400° F. | 32.7 | 31.3 | 29.4 | 25.4 | 24 | — |

One feature of the present invention is that crust formation during baking is minimized.

Additionally, an electrical resistance oven (ERO) was used to measure the viscosity of the commercial batter mix against the test mix prepared with heat activated leavening to demonstrate the differences in viscosity vs. temperature profiles. An ERO utilizes the electrolytic properties of a batter to conduct an electrical charge through the mass. The resistance of the batter to conducting this charge generates heat and thus the batter can be baked uniformly instead of from the outside in as in a conventional oven. A batter product baked in an ERO does not form a crust and does not change in surface color as occurs when a conventional oven or rapid bake oven is used.

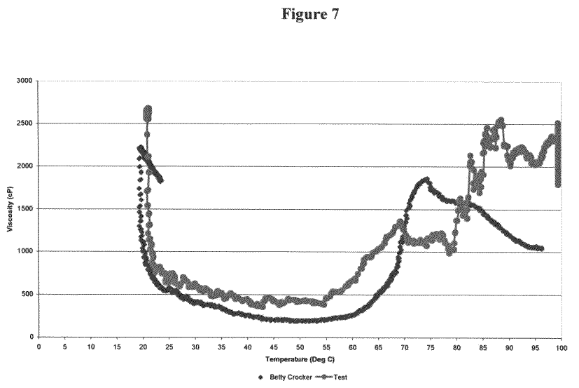

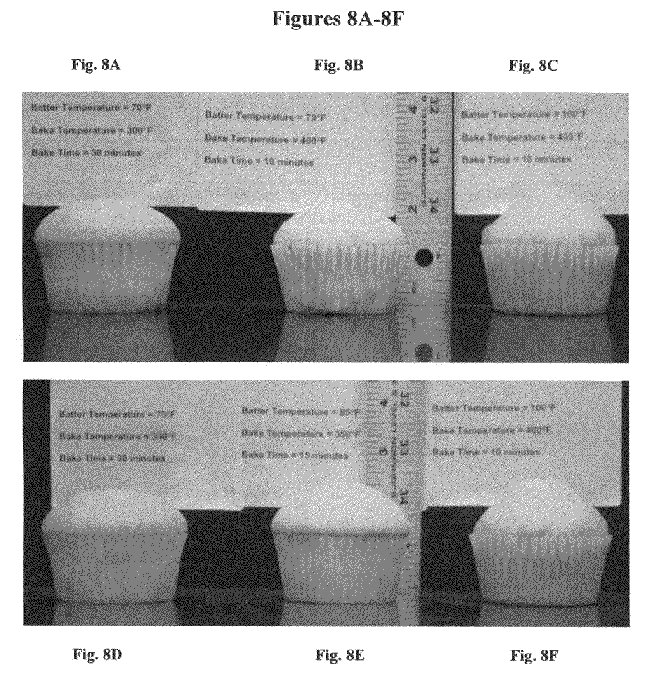

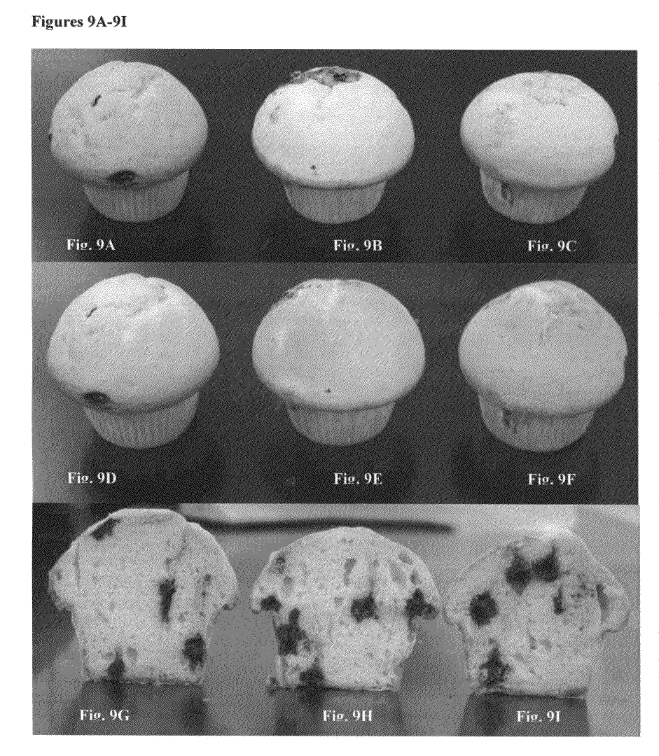

The use of dicalcium phosphate dihydrate results in gas evolution much later than that observed in the commercial batter mix. This difference can be seen in as a rapid jump in viscosity between 80° C. and 90° C. as shown in FIG. 7. This shows how through the use of this leavening, one can raise the temperature of the batter uniformly prior to baking. This tempering process reduces the temperature differential from the batter interior to the exterior, resulting in a reduction of time required to complete the foam to sponge transition throughout the product. The less time in the oven, the lower the time the exterior of the product will dehydrate, brown, and form crust.

### EXAMPLE 3

Muffin batter made according to the test formula and process outlined in Example 2 was prepared and divided into three portions for tempering to various temperature targets prior to baking. This example shows the benefit of decreasing the temperature differential between the internal temperature of the batter and the exterior during the initial bake process, and on shortening bake time at higher bake temperatures while minimizing crust and color formation. Batter was mixed to a final temperature of 70° F. and either immediately placed in the oven or tempered in a temperature controlled chamber to a target temperature prior to baking. Temperature treatments selected were:

1. 70° F. with an oven temperature of 300° F.

2. 70° F. with an oven temperature of 400° F.

2. 85° F. with an oven temperature of 350° F.

3. 100° F. with an oven temperature of 400° F.

Oven times were determined to be complete once expansion was complete and the structure had completed the foam to sponge transition. After removal from the oven, the products were allowed to cool and were blast frozen to −20° F. Height, Width, and colorimeter measurements were taken on the products and are summarized in Table 3.

TABLE 3
Comparison of resulting color and dimensions from batters

| | 300° F. Oven | 350° F. Oven | 400° F. Oven |
|---|---|---|---|
| | Temperature | Temperature | Temperature |
| 70° F. Batter | L = 83.8 | | L = 68.6 |
| Temperature | a* = 1.3 | | a* = 16.5 |
| | Height = 52 mm | | Height = 63.1 |
| | Width = 67 mm | | Width = 63.2 |
| | Bake Time = 30 | | Bake Time = 20 |
| | minutes | | minutes |
| 85° F. Batter | | L = 67.7 | |
| Temperature | | a* = 1.29 | |
| | | Height = 54.2 | |
| | | Width = 65.5 | |
| | | Bake Time = 15 | |
| | | minutes | |
| 100° F. Batter | | | L = 85.4 |
| Temperature | | | a* = 1.2 |
| | | | Height = 58 |
| | | | Width = 62.1 |
| | | | Bake Time = 10 |
| | | | minutes |

### EXAMPLE 4

A larger format muffin made using the slow acting leavening in Example 2 was prepared using frozen fruit. Individually quick-frozen (IQF) blueberries were added at a level of 22% to the batter after mixing according to the process in Example 2. Batter temperatures were measured prior and after the addition of the frozen fruit inclusions. The initial batter temperature of 70° F. was reduced to 52° F. after the addition of the fruit. The fruit containing batter was then divided into 3 portions. The first portion was fully baked at 350° F. for 25 minutes from an initial batter temperature of 52° F. The second portion was allowed to temper for 50 minutes at 120° F. and 90% relative humidity (RH) to a final batter temperature of 90° F., then baked at 350° F. for 17 minutes, just until the structure had fully set. The third portion of batter was allowed to temper for 50 minutes at 120° F. and 90% RH to a final batter temperature of 90° F., then baked at 400° F. for 14 minutes, just until the structure had fully set. Upon cooling, the products were blast frozen in a commercial blast freezer to −20° F. Upon freezing, the samples were measured for maximum height (at the top of the crown), maximum width, and color using a Minolta calorimeter.

After freezing, four of the products from each variable were browned in a TurboChef™ i5 combination oven, a rapid cook oven that possesses microwave and impingement/convection capabilities. A four stage (event) program was used that utilized both microwave energy to thaw and heat the product internally, followed by impingement cooking to brown the surface of the batter products and create a crust more typical of a conventionally baked product. Total cycle time of these products from the frozen state was 2 minutes 30 seconds, and the oven chamber was set to 375° F. The L* and a* values of the fully sponge state product prior to retherming also match those of the 300° F. products in example one, where little to no browning occurred.

TABLE 4
Program parameters used in example 4 for the TurboChef ® i5
rapid combination oven.

| Event | % Time | % Top | % Bottom | % Wave |
|---|---|---|---|---|
| 1 | 25 | 20 | 10 | 50 |
| 2 | 25 | 70 | 20 | 20 |
| 3 | 25 | 100 | 20 | 20 |
| 4 | 25 | 100 | 30 | 10 |

When compared to the L* and a* values of the conventionally baked commercial product in example 1, one can easily see that the L* and a* values of the “rethermed” batter product match well. The negative a* values that are measured on the products increase significantly as browning occurs, which is demonstrated in FIG. 7, where the same muffins shown in the par-bake form are shown after a 2.5 minute program in the rapid combination type oven.

TABLE 5
Comparison of L* and a* values of conventionally baked and
tempered batters made according to example 4, prior to and after
“retherming”

| | Conventional | | |
|---|---|---|---|
| | Bake | Tempered Bake | Tempered Bake, |
| | 350° F./25 min | 350° F./17 min | 400° F./14 min |
| L* | 62.1 | 72.6 | 69.6 |
| a* | 7.3 | −3.0 | −3.0 |
| L*; “rethermed” | — | 57.4 | 54.15 |
| a*; “rethermed” | — | 13.4 | 11.5 |

### EXAMPLE 5

The effects of browning and crust formation in the rapid cook combination oven on product moisture were examined. The larger format muffin made in example 4 was prepared without using frozen fruit. The batter was split into two portions. One portion was conventionally baked at 360° F. for batter was allowed to temper for at 120° F. and 90% RH to a final batter temperature of 90° F., then baked at 360° F. just until the structure had fully set. Upon cooling, the products were blast frozen in a commercial blast freezer to −20° F.

After freezing, samples from each treatment were “rethermed” using the four stage (event) program used in example 4. The moisture content was measured using a standard gravimetric method (AACC 44-15A, 44-31) for pre and post “rethermed” products, and is presented in Table 5. While both the conventionally baked product and the tempered batters have a completely transitioned from foam to sponge, the tempering process has reduced the amount of time required for the transition to occur. This reduction in time results in a higher initial and higher “post-retherm” moistures. These results show that the tempered product lost 3.6% moisture in the “retherm” process, while a conventionally baked product lost 5.8% moisture. Subjectively, the conventionally baked product crust was unacceptably thick and tough after being subjected to the program used in example 4.

TABLE 6
A comparison of finished muffin moistures prepared from
tempered and conventionally baked muffin batters, before and after
“retherming” in a rapid cook combination oven.

| Product | Initial % Moisture | Post-“Retherm % Moisture |
|---|---|---|
| Tempered, Plain | 27.5 | 26.5 |
| Conventionally | 26.1 | 24.6 |
| Baked, Plain | | |

All publications, patents and patent applications cited herein are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of producing a frozen fully-sponge-state batter product that can be browned and undergo crust development from a frozen state in a rapid bake oven to provide a finished product with a color, aroma, texture, and flavor of a freshly baked batter product, comprising the steps of:
(a) depositing a batter composition into a desired form,
(b) initial-baking the batter composition by applying heat to the batter until the batter composition is fully sponge state to form a fully-sponge-state batter product, and
(c) freezing the fully-sponge-state batter product.

2. The method of claim 1, wherein the fully-sponge-state batter product is a white flour batter product and wherein the crust has a calorimeter L*-value of greater than about 65.

3. The method of claim 1, wherein the fully-sponge-state batter product is a white flour batter product and wherein the crust has a colorimeter L*-value of between 85 and 75.

4. The method of claim 1, wherein the fully-sponge-state batter product is a white flour batter product and wherein the crust has a colorimeter a*-value of less than about 5.0.

5. The method of claim 1, wherein the fully-sponge-state batter product is a white flour batter product and wherein the crust has a colorimeter a*-value of between 3.5 and 1.5.

6. The method of claim 1, wherein the fully-sponge-state batter product has a crust thickness of less than 400 micrometers as determined by microscopy or x-ray tomographic measurement of density.

7. The method of claim 1, wherein the fully-sponge-state batter product has a crust thickness between 200 and 100 micrometers.

8. The method of claim 1, wherein the freezing is by blast freezing to an internal temperature of −10 to −40° F.

9. The method of claim 1, wherein the fully-sponge-state batter product has a post bake moisture content of 15-40%.

10. The method of claim 1, wherein the batter composition is tempered to an internal temperature of about 55° F. to 120° F. prior to step (b).

11. The method of claim 1, wherein the batter composition is cooled to an internal temperature of less than about 140° F. prior to step (c).

12. The method of claim 1 1, wherein the batter composition is cooled by vacuum cooling.

13. The method of claim 1, wherein the batter composition comprises a leavening system comprising a heat activated acidulant.

14. The method of claim 13, wherein the heat activated acidulant is dicalcium phosphate dehydrate, sodium aluminum phosphate, or dimagnesium phosphate.

15. The method of claim 13, wherein the leavening system further comprises a second leavening agent.

16. The method of claim 13, wherein the second leavening agent is sodium acid pyrophosphate, calcium acid pyrophosphate, anhydrous monocalcium phosphate, monocalcium phosphate, or sodium aluminum phosphate.

17. The method of claim 1, wherein the initial baking is performed by an electrical resistance oven.

18. The method of claim 1, wherein the rapid bake oven is a combination air impingement/microwave oven or a radiant heat oven.

19. A method of producing a frozen fully-sponge-state batter product that can be browned and undergo crust development from the frozen state in a rapid cook oven to provide a finished baked product with the color, aroma, texture, and flavor of a freshly baked batter product, comprising the steps of:
(a) depositing a batter composition into a desired form, and
(b) applying heat to the batter until the batter composition is fully sponge state and has a crust with an L*-value of greater than about 65.

20. The method of claim 19, wherein the fully-sponge-state batter product is a white flour batter product and wherein the crust has a calorimeter L*-value of between 85 and 75.

21. The method of claim 19, wherein the fully-sponge-state batter product is a white flour batter product and wherein the crust has a colorimeter a*-value of less than about 5.0.

22. The method of claim 19, wherein the fully-sponge-state batter product is a white flour batter product and wherein the crust has a colorimeter a*-value of between 3.5 and 1.5.

23. A method of producing a frozen fully-sponge-state batter product that can be browned and undergo crust development from the frozen state in a rapid cook oven to provide a finished product with the color, aroma, texture, and flavor of a freshly baked batter product, comprising the steps of:
(a) depositing a batter composition into a desired form, and
(b) applying heat to the batter until the batter composition is fully sponge state and a moisture content of between 105% and 110% of the finished baked product.

24. A method of browning and developing a crust on a frozen fully-sponge-state batter product comprising the steps of:
(a) placing the frozen fully-sponge-state batter product into a combination air impingement/microwave oven or a radiant heat oven, and
(b) finish baking the batter product for less than five minutes

25. The method of claim 24, wherein the finish baking in step (b) is for less than two and a half minutes.

26. A batter product comprising a fully-sponge-state batter composition having a moisture content of between 105% and 110% of a corresponding finished baked product, and a crust thickness of less than 400 micrometers.

27. The batter product of claim 26, wherein the batter product has a crust thickness between 200 and 100 micrometers.

28. The batter product of claim 26, wherein the batter product is a white flour batter product and wherein the crust has a colorimeter L*-value of greater than about 65.

29. The batter product of claim 26, wherein the batter product is a white flour batter product and wherein the crust has a calorimeter L*-value of between 85 and 75.

30. The batter product of claim 26, wherein the batter product is a white flour batter product and wherein the crust has a calorimeter a*-value of less than about 5.0.

31. The batter product of claim 26, wherein the batter product is a white flour batter product and wherein the crust has a colorimeter a*-value of between 3.5 and 1.5.
